(19) United States
(12) Patent Application Publication
(10) Pub. No.: US 2023/0374847 A1
(43) Pub. Date: Nov. 23, 2023

(54) APPARATUS AND METHOD FOR FILLING INSULATING GLASS WITH GAS

(71) Applicant: FOREL S.P.A., Roncade (Treviso) (IT)

(72) Inventors: Fortunato VIANELLO, Roncade (Treviso) (IT); Riccardo VIANELLO, Roncade (Treviso) (IT)

(21) Appl. No.: 18/031,020

(22) PCT Filed: Oct. 15, 2021
(86) PCT No.: PCT/IB2021/059504

§ 371 Date: Apr. 10, 2023

(30) Foreign Application Priority Data
Oct. 15, 2020 (IT) 102020000024367

(51) Int. Cl. E06B 3/677; E06B 3/673

(52) U.S. Cl. CPC E06B 3/6775; E06B 3/6733; E06B 3/67365

(57) ABSTRACT

An apparatus for filling insulating glass with gas which has a fixed panel and a movable panel is provided. The fixed panel and the movable panel have respective working surfaces for holding glass panes and are configured to be juxtaposed along a direction perpendicular to the working surfaces to join the glass panes one to the other. The apparatus has closure elements forming a chamber impermeable to fluids between the fixed panel and the movable panel, and suction elements establishing and maintaining a predetermined pressure value inside the chamber.

### FIELD OF APPLICATION

The present invention relates to an apparatus and method for filling insulating glass with gas. In particular, the subject matter of the present invention is an automated device and method for filling insulating glass with gas other than air.

### PRIOR ART

It is known that production lines for making the insulating glass product consist of many processes in cascade and, in particular, comprise the process of filling with gas other than air. The process is known to suffer from a problem associated with the pressure difference between the inside and outside of the insulating glass due to the actual method of manufacturing which, due to compression of the spacing frame, can permanently reduce the volume of the gap to some degree, or because of changed external conditions such as, for example, installation of the finished product at a different elevation than the manufacturing elevation.

In reference to FIG. 1, it is known that a rigid spacer 3 or a flexible spacer 5 pre-coated with sealer 6 and/or adhesive 6′ is placed on a glass pane 2′ and is subsequently joined to another glass pane 2 so that the assembly may then be sealed over the entire outer perimeter thereof so as to constitute the so-called insulating glass 1.

The operation may furthermore be repeated to obtain the insulating glass 1 consisting of three glass panes 2, 2′, 2″ and two rigid spacers 3, 3′ (or flexible spacers 5′), as well as “n” glass panes 2, 2′, 2″, 2″′, 2M, 2′m, 2″m, and “n−1” rigid spacers 3, 3′, 3″ (or flexible spacers 5, 5′, 5″).

More recently, the solution of extruding a thermoplastic product against the surface of one or more of the two or more glass panes 2′, 2″ has been developed, so as to create the spacer profile 7 for the subsequent composition of the insulating glass 1, the situation on which the present invention focuses on effectively and primarily. Preferably, the cross-section of said spacer profile is rectangular. For chemical and physical reasons, and to ensure adequate adhesion between the spacer 7 and the glass, the producers of such thermoplastic materials require that application take place in such a way that the size of the bead deposited on the glass 2′ in the direction perpendicular to the glass is about 10% (up to 12%) greater than the final desired size reached after assembly and pressing of the insulating glass 1.

During the assembly step, after the first glass pane 2 comes into contact with the material of the spacer and has thus achieved a minimal initial seal between the inside gap and the outside of the insulating glass, the panes need to be brought closer to each other so as to reach the desired distance between them and complete adhesion of the thermoplastic material to the glass. In so doing, the volume of the trapped gas is reduced and the pressure inside the insulating unit 1 is increased.

In addition to being risky for the integrity of the glass, this pressure difference between the inside and the outside of the insulating glass causes stresses on the spacer frame, which is pushed toward the periphery and the sealing joint along the entire perimeter, with an attendant risk of seal failure and deformation of the glass panes which are convex toward the outside, resulting in a negative optical effect, especially in the case of external facades. Obviously, these effects are not desirable and there are various attempts to remedy them, not without their drawbacks, in the prior art.

For example, EP 2 422 033 B1 describes a possible solution for solving the problem described above. The idea consists in deforming a sheet of at least one glass pane of the insulating glass before closing the pane against the thermoplastic spacer. In this way, by releasing the deformation of the bent pane only after pressing, an opening is left, allowing the excess gas to escape. However, this solution involves a substantial mechanical complication of the gas filling and pressing machine since the machine needs to be equipped with mechanisms capable of bending a portion of the pane. In addition, there is still the risk that the stress induced by the deformation will cause the glass to break, especially for certain types of glass. Indeed, the inability to use this solution for types of glass panes that are difficult to deform, such as glass panes with large thicknesses or made from laminated glass, is a limitation on this solution.

EP1002925 A2 proposes placing the thermoplastic spacer while reserving a limited area having a size in the direction perpendicular to the glass panes that is the same as the nominal size of the finished product. In this way, the entire perimeter where the spacer has been applied with an oversizing of 10-12% is first closed and pressed, as described earlier, and only after is the gap between the glass panes closed in the area where less material has been deposited. In this way, an escape path is left for the excess gas, which is no longer trapped between the glass panes. But this creates an area of insufficient adhesion and bond between the thermoplastic material of the spacer and the glass precisely because of the lack of proper compression of the material in that area during assembly, which all producers require.

WO 2014/193661 A1 calls for the use of a material capable of absorbing a specific gas present in the mixture placed inside the insulating glass and thereby reducing the internal pressure thereof. However, there is no indication of where said absorbent material can be placed. Apart from the case in which hollow spacers that can contain this gas-absorbing material in their interior are used, if non-hollow spacers are used, such as flexible or thermoplastic spacers, this material would remain inside and would therefore be esthetically unacceptable.

In addition to the situation described thus far, if the product is intended to be installed at an elevation higher than the manufacturing elevation, the condition of the insulating glass having a greater internal pressure than the outside pressure is created, regardless of the type of spacer used.

This last problem, which is not in any way addressed in EP 2 422 033 B1 and EP1002925 A2, is the subject matter of FR2508561A1. However, the proposed device adds a hole to the outside perimeter of the spacer frame which can become a weak point in the finished product in terms of sealing the gas contained in the insulating glass and sealing against moisture in the atmosphere.

GB 794145 proposes a method that also calls for creating a hole in the outside perimeter of the spacer, thus encountering the same problem as FR2508561 A1.

EP 0 389 706 B1 describes a method and device for filling the gap of insulating glass with a gas other than air by making use of a chamber in which a vacuum is established so that the insulating glass can then be filled with the desired insulating gas. However, no mention is made of the problem addressed by the present invention and no explanation is given of how finished products with an internal pressure aligned with the atmospheric pressure of the destination location are obtained.

### DISCLOSURE OF THE INVENTION

Thus, there is a need to resolve the cited drawbacks and limitations in reference to the prior art.

In particular, the main purpose of the present invention is to eliminate the drawbacks of the prior art, by disclosing a device and a method capable of eliminating the problem of internal overpressure in insulating glass units, whether it is due to the production process (thermoplastic spacer) or generated by a different elevation of the installation location of the finished product compared to the manufacturing location.

In this context, one purpose is also to maintain the integrity of the outer wall of the spacer to preserve the effectiveness of the gas and water-vapor seal thereof.

In addition, another purpose is to maintain the esthetic properties of the manufactured product in the internal area thereof, which is visible at the installation location, without the presence of holes or gas-absorbing materials.

In the specific case in which a thermoplastic spacer is used, the intention is to obtain a solution that does not involve complicated and costly modifications of the usual types of machines used to join, press, and fill insulating glass units with gas, and which can be used with all types of glass, including the most rigid ones.

In addition, it is equally important to avoid areas of poor adhesion of the thermoplastic material to the glass due to a lack of the necessary compression of the material, which is typically required in the range of 10-12%, as mentioned earlier, compared to the initial dimension of the spacer during the assembly and pressing step.

In general, there is also the goal of making the production process safe and reliable by avoiding the risk of broken glass due to excessive stress.

These requirements are met at least in part by an automated device for filling insulating glass with gas according to claim 1, and by an automated process for filling the insulating glass with gas according to claim 11.

### DESCRIPTION OF THE DRAWINGS

Further features and advantages of the present invention will become more apparent from the following description of preferred and non-limiting embodiments thereof, in which:

FIGS. 1A-1F show schematic drawings of the cross-sections of insulating glass according to various embodiments;

FIGS. 2A-2C shows schematic drawings of three steps of a process for joining and pressing insulating glass.

FIG. 3 is a schematic drawing of a front perspective view of a portion of an apparatus according to one embodiment of the present invention;

FIG. 4 shows a schematic drawing of a side view of the apparatus in FIG. 3;

FIG. 5 shows a schematic drawing of a rear view of the apparatus in FIGS. 3 and 4; and

FIG. 6 shows a schematic drawing of a plan view of the apparatus in FIGS. 3, 4, and 5.

Elements or parts of elements common to the embodiments described hereinafter will be indicated with the same numerical references.

### DETAILED DESCRIPTION

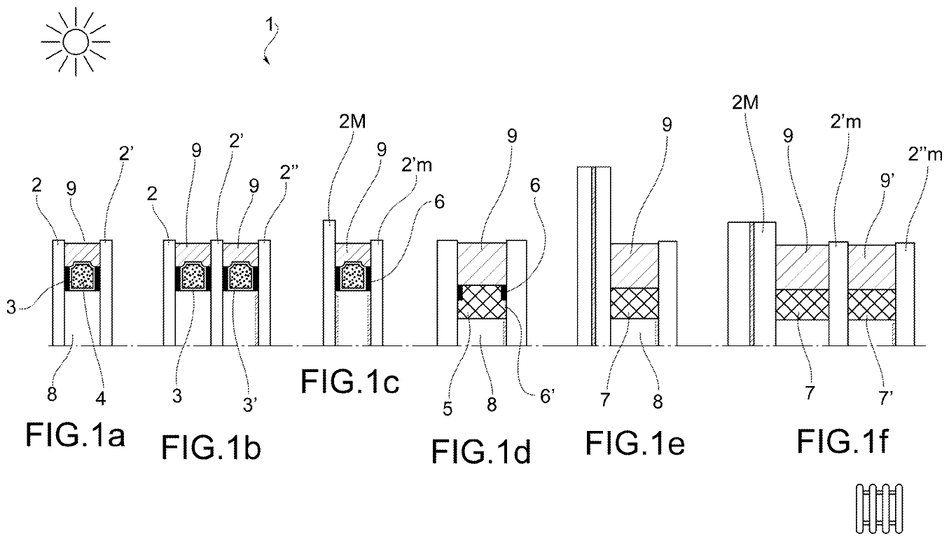

In reference to FIGS. 1A-1F, the inside/outside orientation is visually identified with icons representing the sun (outside) and the radiator (inside).

One can understand from these figures, which only show a few examples, that an insulating glass 1 may have multiple configurations, particularly in the design of the type of spacer, for example a prefabricated rigid-profile spacer 3, a flexible-profile spacer 5, unwound from a coil before being applied to the glass, or a spacer 7 made of thermoplastic product extruded directly onto the glass.

FIGS. 1A to 1F are schematic drawings of peripheral portions of an insulating glass 1 in a non-exhaustic series of examples of possible combinations (showing rigid frames, flexible frames, and thermoplastic frames).

In greater detail, based on the type of glass used:
FIG. 1A shows a “normal” insulating glass 1 in which two glass panes 2, 2′ are joined together;
FIG. 1B shows an insulating glass 1 made with three panes, with internal glass 2″ having a low-emissivity coating;
FIG. 1C shows an insulating glass 1 with external glass 2M with a selective coating and offset with respect to the inside glass 2′m having a low-emissivity coating;

FIG. 1D shows an insulating glass 1 made with tempered outside glass and inside glass having a low-emissivity coating;

FIG. 1E shows an insulating glass 1 made with a laminated outside glass offset with respect to the inside glass having a low-emissivity coating and spacer 7 made of thermoplastic material;

FIG. 1F shows an insulating glass 1 made with three panes, with a laminated outside glass offset with respect to the other two panes, in which the inside pane has a low-emissivity coating and spacers 7, 7′ made of thermoplastic material.

FIGS. 1A, 1B, and 1C show a hollow rigid spacer 3 with a profile made of metal (typically aluminum or stainless steel or a combination of stainless steel and polymer material) or polymer material filled with hygroscopic material 4.

FIG. 1D shows a flexible spacer 5 incorporating the hygroscopic material 4 into the mass thereof.

FIGS. 1E and 1F show a thermoplastic spacer 7 incorporating the hygroscopic material 4 into the mass thereof.

As an example, cross-sections of the two types of sealant used are shown: shown in solid black is the butyl sealant 6 serving the purpose of initial bond between the components and sealing (first sealing and primary sealant); in the case of a flexible spacer, an acrylic adhesive 6′ (indicated but not shown since the thickness is only a few μm) or the combination of acrylic sealant 6′ and butyl sealant 6 applied between the receptacles of the side surfaces of the spacer and panes, as shown in the example of FIG. 1D, can be used in its place. In addition, also as an example, a polysulfide (PS) or polyurethane (PU) or silicone (SI) sealant 9 serving the function of mechanical bond to the edge and sealing (second seal and secondary sealant) applied between the outer surface of the spacer and the surfaces of the glass panes up to the edge of the glass panes or the glass pane 2′m of lesser dimension (in the case of offset glass panes), is shown with wide hatching.

The secondary sealant also makes a contribution, albeit less than that of the primary sealant, in sealing against the entry of moisture and the escape of gas 8.

FIGS. 1E and 1F show cases in which the spacer 7 is made of extruded thermoplastic product, where the present invention contributes to the interfacing with the glass pane using an innovative solution.

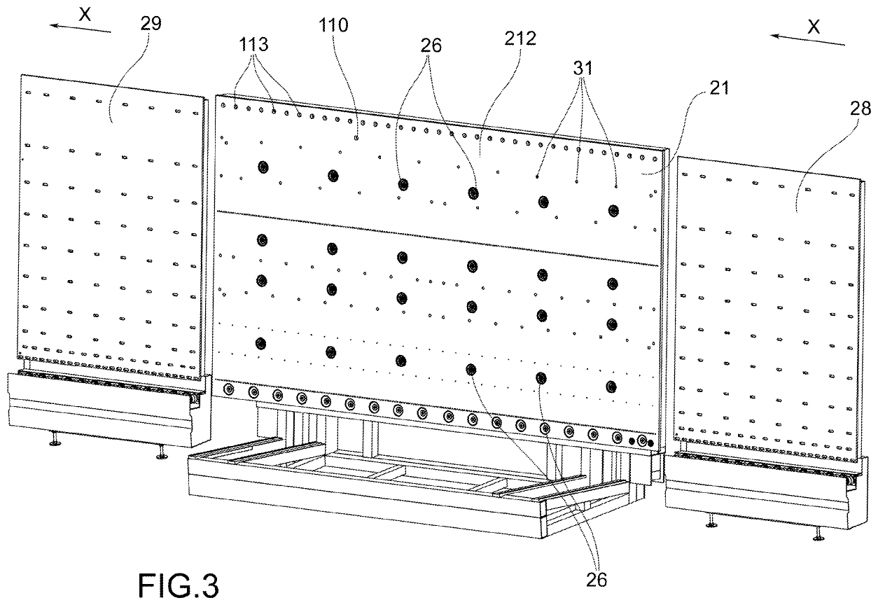

FIGS. 3-6 show an apparatus 10 for filling insulating glass 1 with gas.

The apparatus 10 comprises: a fixed panel 21 and a movable panel 22 in which the fixed panel 21 and the movable panel 22 have respective working surfaces 212, 222 for holding glass panes 2, 2′.

The fixed panel 21 and the movable panel 22 are suitable for being brought closer to each other in a direction (Z) perpendicular to the two working surfaces 212, 222 so as to join glass panes 2, 2′ together.

The apparatus 10 comprises:
closure means 102, 107, 108, and 109 for forming a chamber 112 impermeable to fluids between the fixed panel 21 and the movable panel 22;
suction means 104, 105, 111, and 106 for establishing and maintaining a given pressure value inside the chamber 112 while the panes 2, 2′ are being joined together to make the insulating glass 1.

According to a possible embodiment, the apparatus further comprises blowing means 25 for blowing a gas into said chamber 112.

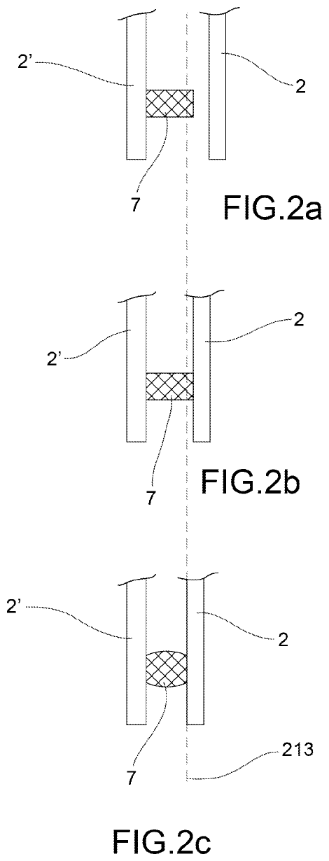

FIGS. 2A-2C show in three successive steps what happens inside the chamber 112 if a thermoplastic spacer 7 is used and after the glass panes 2, 2′ have been positioned correctly, with the glass pane 2 held by surface 222 of the movable panel 22, for example by suction pads (not shown), and with the glass pane 2′ held by the surface 212 of the fixed panel 21, for example by means of suction pads 26.

In FIG. 2A, the glass panes 2, 2′ are in the gas filling position. In FIG. 2B, the glass panes 2, 2′ are in the position in which the pane 2 has come into contact with the thermoplastic spacer 7, but pressing to the final distance between the two panes 2, 2′ has not yet occurred. In FIG. 2C, both panes have reached their final position after pressing. The dashed line 213, which is common to FIGS. 2A-2C, indicates the final position of the inside surface of the glass pane 2 and therefore highlights in FIG. 2A the additional material deposited with respect to the final dimension of the thermoplastic spacer 7. FIG. 2B shows the condition of initial hermetic sealing of the gap defined by the glass panes 2 and 2′ and by the spacer 7, but with the panes not yet at their final distance, and lastly FIG. 2C shows the final condition of panes 2 and 2′ joined and pressed, with the resulting reduction of the volume of the inside gap.

FIG. 3 shows a perspective view of a possible embodiment of the fixed panel 21 of the apparatus 10. As shown in the figure, the fixed panel 21 of the apparatus may comprise suction holes 113 and holes 31 to create an air cushion, which is useful for transporting the glass panes. Also shown are suction pads 26 for flattening the glass panes, which facilitate gas injection.

In addition, still in reference to FIG. 3, the opposing movable panel 22 is not shown for graphical reasons, whereas according to one embodiment an input conveyor 28 and a output conveyor 29 are shown. The input conveyor 28 and the output conveyor 29 will not be described in further detail, as they are already known to a person skilled in the art.

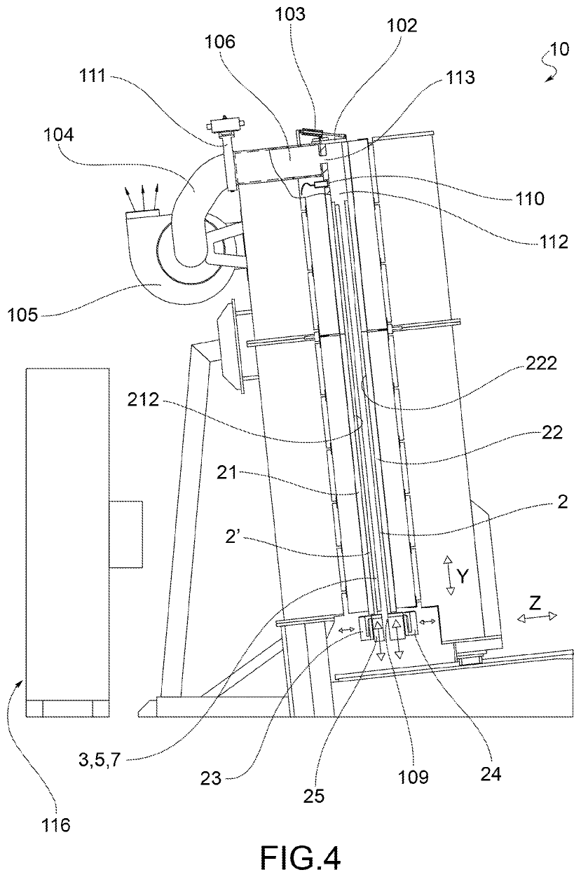

FIG. 4 shows a side view of a possible embodiment of the apparatus 10 in the position of gas injection to replace air, i.e. with panes 2 and 2′ correctly positioned but not yet joined together, and the second pane 2′ with spacer 3 or 5 or 7 already applied. In addition, the fixed panel 21 and the movable panel 22 are shown.

According to a possible embodiment, the closure means may comprise an upper sealing window 102. The window 102 may be moved, for example, by a cylinder 103 which may be pneumatic, for example. FIG. 4 shows that the upper sealing window 102 is positioned in the closed position in the upper part of the apparatus along with the cylinder 103 for controlling it.

Advantageously, the window 102 may extend by an amount substantially equal to the size of the interface between the movable panel 22 and the fixed panel 21.

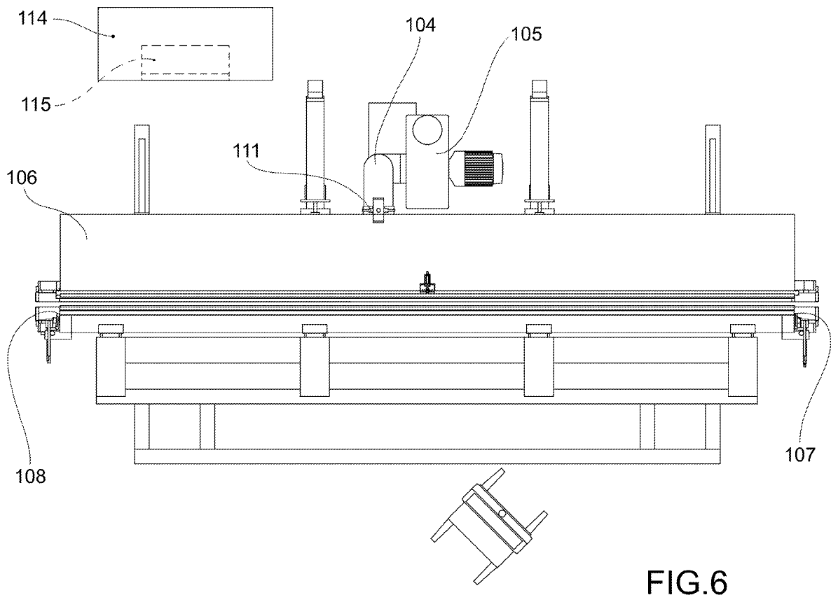

In addition, the closure means comprise lateral sealing windows 107, 108 and a lower sealing gasket 109. FIG. 6 shows the apparatus 10 viewed from the top with the lateral sealing windows 107 and 108 showing.

The lateral windows 107, 108 are arranged on the sides of the upper sealing window 102 and have a size substantially equal to the respectives sides of the interface between the fixed panel 21 and the movable panel 22.

According to a possible alternative embodiment, the closure means may be made with a rubber membrane. Advantageously, thanks to their flexibility, the rubber membranes easily make it possible for relative movement between the movable panel 22 and the fixed panel 21.

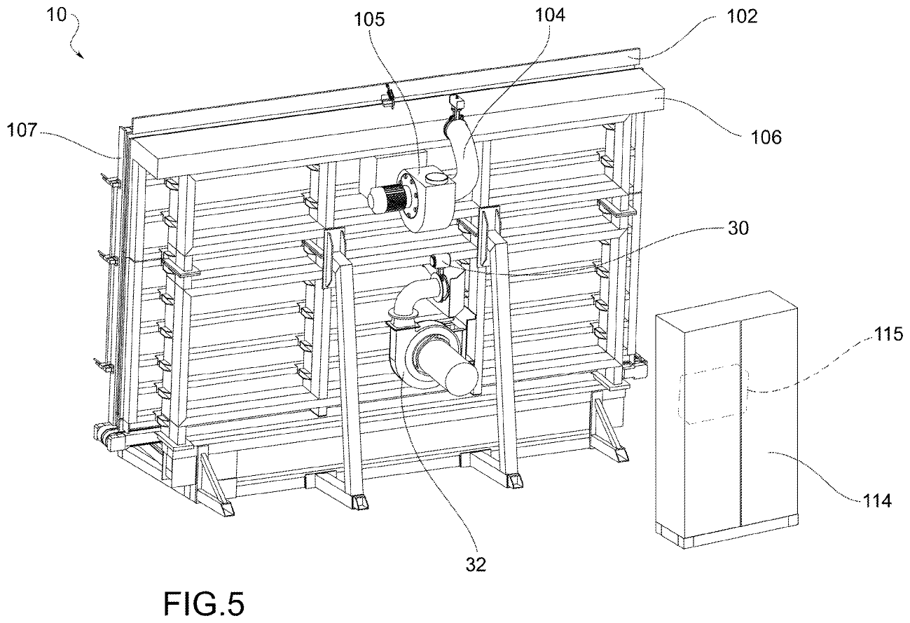

FIGS. 4 and 5 show a possible embodiment of the suction means. In particular, the suction means may comprise a blower 105 with the suction side connected to a duct 104 that leads to a shutoff valve 111, such as a three-way shutoff valve, and then to a manifold 106. Advantageously, the manifold 106 may be designed to uniformly distribute the airflow moving from the chamber 112 to the outside.

FIG. 5 shows the rear view of the apparatus 10 with the blower 105, the duct 104, and the manifold 106 for air suction and creation of a partial vacuum. As can be seen in the figure, the manifold 106 may have a shape that is substantially parallel to the direction of the upper sealing window 102 and may lie along the upper edge of the fixed panel 21.

According to a possible alternative embodiment, the suction means may comprise a vacuum pump, for example a positive displacement pump, in place of the blower 105.

According to yet another alternative embodiment, the suction means may comprise an ejector based on the Venturi effect. In particular, the apparatus may be arranged on the upper side of a duct inside which an airflow roughly parallel to the upper edge of the apparatus is made to flow so as to generate a pressure drop in the inner chamber 112. Advantageously, in this case a sealing system in the upper portion of the apparatus 10 is not needed.

A possible embodiment of an apparatus 10 according to the present invention will now be described in detail.

Here, the term vertical is used in the description of the components of the apparatus with the intention that said components are in actuality slightly inclined (typically about 6 degrees) with respect to vertical, as is customary for vertical glass-pane conveyors to be built.

In addition, automated insulating-glass production lines are very well known both to persons skilled in the art and less qualified persons involved in processing, so in the following only the operations of gas filling, joining, and pressing are described, which are performed by the apparatus 10 as indicated above, forming the subject matter of the inventive portion of the present invention.

As mentioned earlier, the apparatus 10 comprises a fixed panel 21 and a movable panel 22 in a vertical position, in which the fixed panel 21 is aligned with an input conveyor 28 and with an output conveyor 29, and a movable panel 22 movable in a direction Z orthogonal to the panels. According to a possible embodiment, the movable panel 22 may be designed to also move in a vertical direction Y substantially perpendicular to direction Z, i.e. to the opening direction of the movable panel 22, and to the transport direction X of the glass panes 2.

The first glass pane may enter the apparatus 10 supported by a conveyor 23, which may consist, for example, of a motorized belt or motorized rollers, and by the fixed panel 21.

In a possible alternative embodiment, the glass pane 2 may also be brought inside the apparatus 10 by a conveyor 24 appropriately positioned for this purpose. This last mode has the advantage of initiating the process with the conveyor 24 already in the correct position for the subsequent steps, thus shortening the cycle time.

To facilitate transport of the glass pane 2, an air cushion is created between the fixed panel 21 and the glass pane 2 by a multitude of holes 31 which bring the air coming from one or more blowers 32, which can also be equipped with one or more shutoff valves 30. Known sensors, not shown, allow the glass pane 2 to be slowed down and stopped in the correct position. In this situation the shutoff valves 30 are closed, thus stopping the air cushion on the fixed panel 21 and allowing the movable panel 22 to approach the glass pane 2 until it presses against it and seizes it by means of an array of suction pads (not shown as they are known to a person skilled in the art) distributed throughout the movable panel 22, then the movable panel 22 moves away from the fixed panel 21 along the Z axis, carrying with it the first glass pane 2 to a height that is more than sufficient, after reactivation of the air cushion on the fixed panel 21, to allow for insertion of the second glass pane 2′, together with the spacer, which has been applied to it at the previous station. After the glass pane 2′ has been positioned correctly by the conveyor 23, with feedback from known slowing and positioning sensors, the two glass panes 2 and 2′ are in front of each other, the air cushion of the fixed panel is deactivated by valves 30, and the suction pads 26 of the fixed panel are activated. The movable panel 22 then moves along the Z axis to bring the glass pane 2 to a distance of a few mm from the spacer applied to the glass pane 2′ (generally 1 to 3 mm, more typically 1.5 mm). At this point the upper windows 102, lateral input window 107, and lateral output window 108, are closed and appropriate known mechanisms bring the gas injection manifold 25; the gasket 109, such as a tubular inflatable gasket, ensures a seal in the lower portion of the machine.

In this situation the elements of the insulating glass 1 are located inside a closed chamber 112 consisting of two panels 21 and 22, the upper windows 102, the lateral windows 107 and 108, and the gasket 109 in the lower portion. By opening the shutoff valve 111, the chamber 112 is allowed to communicate with the suction side of the blower 105. The blower 105 runs continuously so that the cycle time is not lengthened by the startup phase. The pressure inside the chamber 112 is then raised to a value lower than the outside atmospheric pressure as established by the production cycle settings. The resulting partial vacuum can be measured by a pressure sensor 110, which sends the measurement to a control unit 116 controlling the machine so that the number of rotations of the blower 105 can be varied accordingly through an inverter 115 which can be placed inside an electric panel 114.

Using a suitable algorithm based on the characteristic curve of the blower being used, the dimensions and composition of the insulating unit being produced, and the desired final internal pressure value, the correct number of rotations of the blower is calculated so that changes in the rotational speed of the blower 105, which would entail an increase in the cycle time, are not required during the cycle. Note that maintaining the desired partial vacuum does not require large amounts of air, but only enough to compensate for the minimal but inevitable sealing losses of the chamber 112 inside the apparatus 10.

In the subsequent step, once the proper partial vacuum has been reached, the gas is blown in through the manifold 25 until the insulating glass 1 is completely filled; in the meantime the blower 105 continues to maintain the desired partial vacuum, including during the step of gas injection to replace the air; next, the movable panel 22 closes against the fixed panel 21 thus joining together the glass panes 2 and 2′ and the spacer frame 3, 5, 7, and simultaneously pressing to the nominal dimension corresponding to the required distance between the glass panes 2, 2′ of the finished product.

Obviously, as soon as the desired distance between the two panes 2 and 2′ is reached during the pressing step, the valve 111, being a three-way valve, closes off communication between the blower and the inside of the chamber 112 and, at the same time, allows outside air to repressurize the chamber 112. The windows 102, 107, and 108 are opened and the movable panel 22 moves away from the assembled and pressed insulating glass unit 1 after the suction pads on the fixed panel 21 and on the movable panel 22 have been deactivated. At this point, the product can be transported to the next station for completion of the production cycle.

In the specific case where a thermoplastic spacer is used, the size of the bead applied at the appropriate station is always increased (generally by 10-12%) in the direction perpendicular to the plane of the glass pane 2′ compared to the final desired nominal value. This facilitates and ensures proper adhesion of the thermoplastic material to the glass during the pressing step when the distance between the two glass panes 2 and 2′ is reduced to the correct desired nominal value. In this way, the space occupied by the gas trapped inside the chamber 112 at the time of contact between the spacer bead and the glass pane is reduced, with an attendant increase in the pressure inside the chamber. However, since assembly occurs at a pressure below the atmospheric pressure outside the chamber 112, the effect of the pressing only brings the pressure inside the insulating glass up to a value very close to the outside, thus eliminating the described problem.

According to one aspect of the present invention, the process of filling the insulating glass 1 with gas comprises the following steps:
arranging an apparatus as described earlier; and
maintaining a predetermined pressure value inside the chamber 112 between the fixed panel 21 and the movable panel 22 that is below the pressure outside the chamber 112 as the movable panel 22 is brought to the fixed panel 21, and subsequent joining of the glass panes 2, 2′ of the insulating glass 1.

The pressure value maintained inside the chamber 112 may be such that, during the joining and pressing step of the glass panes 2, 2′ after spacer 3, 5, 7 has been squeezed, the pressure value of the gas inside the insulating glass is substantially the same as the pressure outside the insulating glass.

According to a possible embodiment, the pressure value maintained inside the chamber 112 is such that, during the joining and pressing step of the glass panes 2, 2′ after spacer 3, 5, 7 has been squeezed, the pressure value of the gas inside the insulating glass is substantially the same as the pressure of the location where the insulating glass 1 is to be installed.

According to a possible embodiment, if a thermoplastic spacer 7 is used, the process may comprise a step in which the pressure of the chamber 112 is regulated as the movable panel 22 is brought to the fixed panel 21 after the two glass panes 2, 2′ and the spacer 7 have been joined together, in order to achieve the necessary squeezing of the spacer 7 in proportion to the movement of the movable panel 22.

In this way, it is possible to prevent any difference in pressure between the inside of the insulating glass 1 and the chamber 112 caused by the reduced volume of the internal chamber of the insulating glass, and therefore any stress involving an undesirable deformation of the thermoplastic spacer 7.

In order to achieve the described pressure regulation of the chamber 112, the valve 111 may be provided with a proportional control for adjusting the pressure of the chamber 112 as a function of the feedback from the pressure sensor 110 and the position of the movable panel 22 with respect to the fixed panel 21.

According to a possible embodiment, pressure regulation of the chamber 112 may be achieved by acting on the variation in the number of revolutions of the blower 105 by means of the inverter 115.

Regulation of the pressure inside the chamber 112 may be omitted or suitably adjusted if one wishes to obtain a pressure at the end of the production process that is different from the pressure of the production location but similar to that of the final destination of the insulating glass.

Advantageously, to regulate the pressure value inside the insulating glass 1, the control unit 116 may comprise a user interface through which the elevation of the installation location of the insulating glass 1 may be selected.

The process may comprise a step for injecting gas into the chamber 112 before the glass panes 2, 2′ are made into the insulating glass 1. Alternatively, gas injection may be eliminated if the insulating glass is to be filled with air.

When any of the types of spacer are used, it is possible with the described device and method to obtain the insulating glass 1 with an internal pressure lower than the atmospheric pressure of the production location but corresponding to the pressure of the installation location, if it is at a higher elevation.

In particular, it is possible to obtain a combination of two results, i.e. insulating glass using the thermoplastic spacer and having an internal pressure below the atmospheric pressure of the production location corresponding to the atmospheric pressure of the installation location of the insulating glass 1.

If the insulating glass 1 consists of more than two glass panes 2 (typically three) and more than one spacer frame 3, 5, 7 (tyically two), the apparatus 10 completes one more cycle before outputting the insulating glass 1 as made in the steps described above, i.e. two glass panes and one spacer frame: the movable panel 22 is reopened as described above, seizing said insulating glass 1, waits for the positioning of a third glass pane 2″ equipped with a second spacer frame 3′ or 5′ or 7′, approaches as described above, and, after injection of the gas according to the sequence described above, performs a second joining and a second pressing. The process may be repeated in the case of a four-pane glass, and so on.

The present invention is capable of numerous embodiment variants, all of which fall within the scope of equivalence to the inventive concept such as, for example and in particular, the mechanical solutions for sealing the chamber 112 inside the apparatus 10, the construction details of which may be replaced with other equivalent ones, the drives, the recordings, and the means of actuation which may be electric, electrical- electronic, pneumatic, hydraulic, and/or combined, etc., the control means which may be electronic or fluidic and/or combined, etc.

The construction details may be replaced with other technically equivalent ones.

The above description and figures refer to an apparatus 10 arranged according to a process flow from right to left; it is easy to imagine a description and corresponding figures in the case of mirrored or otherwise different layouts, for example including a change in the direction of the line.

A person skilled in the art will be able to make modifications to the embodiments described above and/or substitute described elements with equivalent elements in order to satisfy particular requirements, without departing from the scope of the accompanying claims.

1. An apparatus for filling insulating glass with gas, comprising:
a fixed panel and a movable panel; said fixed panel and said movable panel having respective working surfaces configured to hold glass panes; said fixed panel and said movable panel being configured to be juxtaposed along a direction perpendicular to the two working surfaces to join said glass panes to each other;
wherein said apparatus further comprises
closure means configured to form a chamber between said fixed panel and said movable panel; and
suction means configured to establish and maintain a predetermined pressure value inside said chamber as the glass panes are joined for making the insulating glass.

2. The apparatus for filling insulating glass with gas according to claim 1, further comprising blowing means designed configured to blow gas into said chamber.

3. The apparatus for filling insulating glass with gas according to claim 1, wherein said closure means comprise an upper sealing window, lateral sealing windows, and a lower gasket, said upper and lateral sealing windows and said lower gasket acting between said fixed panel and said movable panel, said upper and lateral sealing windows being movable between a closed position in which the upper and lateral sealing windows make said chamber impermeable to fluids between said fixed panel and said movable panel; and an open position in which said chamber is in fluid communication with an external environment.

4. The apparatus for filling insulating glass with gas according to claim 1, wherein said closure means are made with a rubber membrane.

5. The apparatus for filling insulating glass with gas according to claim 1, wherein said suction means comprise a blower with a suction side connected to a pipe leading to a shutoff valve, and to a manifold placed on a rear surface of the fixed panel.

6. The apparatus for filling insulating glass with gas according to claim 1, wherein said suction means comprise a positive displacement vacuum pump with a suction side connected to a pipe leading to a shutoff valve, and to a manifold placed on a rear surface of the fixed panel.

7. The apparatus for filling insulating glass with gas according to claim 6, wherein said manifold has a shape substantially parallel to a direction of the upper sealing window, and lies along upper edge of the fixed panel.

8. The apparatus for filling insulating glass with gas according to claim 2, wherein said blowing means comprise an injection manifold arranged on said fixed panel at an edge in front of a manifold placed on a rear surface of the fixed panel.

9. The apparatus for filling insulating glass with gas according to claim 1, further comprising a pressure sensor connected to a control unit, configured to measure pressure inside the chamber, said control unit being signed configured to act accordingly on said suction means.

10. The apparatus for filling insulating glass with gas according to claim 1, wherein said gas is a gas other than air.

11. A method for filling insulating glass with gas, the method comprising:
providing an apparatus for filling insulating glass with gas, comprising:
a fixed panel and a movable panel; said fixed panel and said movable panel having respective working surfaces configured to hold glass panes; said fixed panel and said movable panel being configured to be juxtaposed along a direction perpendicular to the working surfaces to join said glass panes to each other;
wherein said apparatus further comprises
closure means configured to form a chamber between said fixed panel and said movable panel; and
suction means configured to establish and maintain a predetermined pressure value inside said chamber as the glass panes are joined for making the insulating glass; and
maintaining inside the chamber between said fixed panel and said movable panel a predetermined pressure value lower than pressure outside the chamber, during juxtaposition of said fixed panel and said movable panel and subsequent joining of the glass panes of the insulating glass.

12. The method for filling insulating glass with gas according to claim 11, wherein the predetermined pressure value maintained inside the chamber is such that during joining and pressing of the glass panes following squeezing of a spacer, the value of the gas pressure inside the insulating glass is substantially the same as the pressure outside the insulating glass.

13. The method for filling insulating glass with gas according to claim 11, wherein the predetermined pressure value maintained inside the chamber is such that during joining and pressing of the glass panes following squeezing of a spacer the value of the gas pressure inside the insulating glass is substantially the same as the pressure of an installation site where the insulating glass is to be installed.

14. The method for filling insulating glass with gas according to claim 13, wherein to adjust pressure inside the insulating glass, the control unit comprises a user interface wherein elevation of the installation site is selectable.

15. The method for filling insulating glass with gas according to claim 11, the method further comprising blowing gas into said chamber before the glass panes form the insulating glass.

16. The method for filling insulating glass with gas according to claim 11, wherein, if a thermoplastic spacer is used, the method comprises a step wherein, as the movable panel is brought to the fixed panel after the glass panes and the thermoplastic spacer have been joined together to squeeze the thermoplastic spacer, pressure in the chamber varies in proportion to movement of the movable panel.

17. The apparatus for filling insulating glass with gas according to claim 5, wherein the shutoff valve is a three-way valve.

18. The apparatus for filling insulating glass with gas according to claim 6, wherein the shutoff valve is a three-way valve.
